(19) United States
(12) Patent Application Publication
(10) Pub. No.: US 2021/0206113 A1
(43) Pub. Date: Jul. 8, 2021

(54) TRANSFORMING PROPERTY DATA TO COMPENSATE FOR PROPERTY VALUE SHIFTS

(71) Applicant: HEWLETT-PACKARD DEVELOPMENT COMPANY, L.P., Spring, TX (US)

(72) Inventors: Morgan T. SCHRAMM, Vancouver, WA (US); Matthew A. SHEPHERD, Vancouver, WA (US); David M. BERFANGER, Vancouver, WA (US); Jay S. GONDEK, Vancouver, WA (US)

(73) Assignee: HEWLETT-PACKARD DEVELOPMENT COMPANY, L.P., Houston, TX (US)

(21) Appl. No.: 16/075,605

(22) PCT Filed: Jul. 28, 2017
(86) PCT No.: PCT/US2017/044420

§ 371 Date: Aug. 4, 2018

(51) Int. Cl. B29C 64/393; B22F 10/20; B22F 10/38; G06F 30/20

(52) U.S. Cl. CPC B29C 64/393; B22F 10/20; B33Y 40/00; G06F 30/20; B22F 10/38

(57) ABSTRACT

In an example, a method includes receiving a data model of an object to be generated in additive manufacturing, the data model comprising geometric object data describing the object and property data. A property affecting object generation parameter may be determined for the object and a modified data model of the object may be derived by applying a transformation to the property data associated with the property affecting object generation parameter, wherein the transformation is to compensate for a property value shift associated with the property affecting object generation parameter.

### BACKGROUND

Three-dimensional (3D) printing is an additive manufacturing process in which three-dimensional objects may be formed, for example, by the selective solidification of successive layers of a build material. The object to be formed may be described in a data model. Selective solidification may be achieved, for example, by fusing, binding, or solidification through processes including sintering, extrusion, and irradiation. The quality, appearance, strength, and functionality of objects produced by such systems can vary depending on the type of additive manufacturing technology used.

### BRIEF DESCRIPTION OF DRAWINGS

Non-limiting examples will now be described with reference to the accompanying drawings, in which:

FIG. 1 is an example of a method for modifying a data model to compensate for a property value shift due to a property affecting object generation parameter;

FIG. 2 is an example of a method of determining print instructions for generating an object;

FIGS. 3 and 4 are examples of apparatus for processing data relating to additive manufacturing; and

FIG. 5 is an example of a machine readable medium in association with a processor.

### DETAILED DESCRIPTION

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material melts, coalesces and solidifies to form a slice of the three-dimensional object in accordance with the pattern. In other examples, coalescence may be achieved in some other manner.

In addition to a fusing agent, in some examples, a print agent may comprise a coalescence modifying agent (which may be referred to as modifying or detailing agents), which acts to modify the effects of a fusing agent and/or energy applied, for example by inhibiting, reducing or increasing coalescence or to assist in producing a particular finish or appearance to an object.

A property modification agent, for example comprising a dye, colorant, a conductive agent, an agent to provide transparency or elasticity or the like, may in some examples be used as a fusing agent or a modifying agent, and/or as a print agent to provide a particular property for the object.

Additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data may in some examples be processed to generate slices of parallel planes of the model. Each slice may define at least a portion of a respective layer of build material that is to be solidified or caused to coalesce by the additive manufacturing system.

In some additive manufacturing systems, a property such as object strength, color, density or the like of an object generated using a particular print instruction (wherein the print instruction may specify coverage of a print agent or a coverage of each of a plurality of print agents) may vary based on object generation parameters. For example, a property such as color may vary based at least in part on angles of surfaces of the 3D object. In other words, in some examples of additive manufacturing, there may be angular color dependency characteristics that may affect visual appearance of the color for some objects which are produced using a consistent combination of object generation materials. Thus, a particular combination of print agents may result a first color on a face with a first angle and a second color on a face with a second angle. Generally, as the term is used herein, an angle generally refers to one or more angles (e.g., one angle, two angles, three angles, etc.) of a surface normal for a surface.

Other parameters may also impact the properties of an object. For example, a property may vary according to the position within a printing volume of the system (for example, a particular object generation instruction may result in a different color or object strength in one position of the printing volume than in another, where one location is for example higher, lower, more central or closer to a given side within the build volume than the other). As another example, a property produced using a particular print instruction may vary according to the operating temperature of the object generation apparatus (such that an object generated using a particular combination of build materials may be have one property value (e.g. a value indicative of color/strength/density or the like) when printed at a first temperature and the property value may be different when printed at a second temperature). Different object generation apparatus may produce different properties using the same print instructions.

FIG. 1 shows an example of a method which may be a computer implemented method, for example carried out using at least one processor, and may comprise a method of deriving a modified data model of an object in which property data is transformed to compensate for an object generation parameter property dependence (e.g. a surface orientation, an object generation location within a build volume, an object generation temperature, an object generation class or type, or the like). In some examples, transformation is to increase consistency of at least one property in a generated object.

Block 102 comprises receiving a data model of an object to be generated in additive manufacturing, the data model comprising geometric object data describing the object and property data, which may describe at least one property of the object.

The data model may for example be received by a processor from a memory, over a network, over a communications link or the like.

The geometric object data may define a three-dimensional geometric model of at least a portion of the model object, including the shape and extent of all or part of an object in a three-dimensional co-ordinate system, e.g. the solid portions of the object. In some examples, the data model may represent the object, or the surfaces of the object, as a mesh of polygons. In some such examples, the faces of the polygons may be associated with orientation data, for example, surface normal orientation vectors (or such vectors may be derivable). The object model data may for example be generated by a computer aided design (CAD) application, or by a designer.

The property data may for example comprise a property ‘map’, which is associated with at least a portion of the object. There may be a mapping between locations of the object and the property map, and a property map may be any property data associated with such a mapping. In some examples, a property map may be associated with just the object's surface(s), while in other examples a property map may be associated with one or more interior portions of the object. A property map may comprise a 2D image file that can be applied to a 3D model to add color, texture, or other properties like glossiness, reflectivity, conductivity, transparency, strength, or the like. A property map may relate to a particular property, for example defining the coloration of the object over its surface (and thus providing surface patterns and the like). In other examples, 3D property maps may be provided.

In some examples, such property maps may correspond to an ‘unwrap’ model of an object's surface. For example polygons describing the object's surface may be arranged so as to lie in a 2D plane, and may be described by a uv coordinate system (as compared to the xyz coordinate system used to describe the object in 3D). A property map may be associated with the location in an object surface and/or an object interior so as to correspond with the uv coordinates of an unwrapped 3D model, via a mapping, which may be referred to as a uv mapping.

For example, coordinates in a 2D property map may be associated with the vertices (i.e. corners) of the polygons of an object model via a uv mapping. In some examples, a model of an object may be expressed in two parts: (a) object model data representing the object as a plurality of initial polygons, i.e. a mesh, which has 3D rectilinear coordinates in xyz and (b) object property data, e.g. bitmap(s), which have 2D rectilinear coordinates in uv (the uv space may be effectively the bitmap xy space, but is termed uv to avoid confusion with the 3D coordinate system).

In one example, the polygon mesh is a triangular mesh representing a surface of the object and each triangle in the mesh has three vertices and six pieces of information—the xyz coordinates v0, v1 and v2 (the location of the polygon vertices in 3D space) and the uv coordinates uv0, uv1, and uv2 (the location of the vertices in the 2D space of the bitmap(s)). The uv coordinates may not have the same shape as the xyz coordinates, they can be three arbitrary points (or even the same point(s)) on the bitmap(s)). Further, they can be independently determined for each polygon, where one polygon's uv coordinates in general do not affect any other polygon's uv coordinates. In this way, the properties at the vertices are given by the uv coordinates. For the remainder of a given polygon (the edges and interior), these properties may be derived, for example interpolated (e.g. linearly interpolated), from the three uv vertices.

While the example of a triangle has been used here, the mesh may be based on a different polygon, for example comprising a tetrahedral mesh (which comprises polygon faces). In such a mesh, the properties may again be defined at the vertices.

In other examples the object property data may be specified in some other way so as to define at least one object property for at least a portion of the three-dimensional object to be generated. For example, property data may be associated with voxels of the object model, as described in greater detail below, associated with polygon faces, specified volumetrically or as an algorithm, or in some other form.

In one example, the object property data may comprise any or any combination of color data, flexibility, elasticity, rigidity, surface roughness, porosity, inter-layer strength, density, transparency, conductivity and the like for at least a portion of the object to be generated. The object property data may define multiple object properties for a portion or portions of an object, and the properties specified may vary over the object.

Where a plurality of properties are described in one or more property data sources/maps, at least some such properties may have an interdependence. For example some colors may not be achievable in the same object as a specified object strength, transparency, buoyancy or the like. In some examples, a property affecting object generation parameter may impact one property in a different manner than another property. Effects of such interdependence is discussed below.

If no object property data is present the object may have some default properties based on the build material and print agents used.

In some examples, there may be a plurality of property maps and/or property data sources (e.g. data files, databases, look up tables and the like) associated with an object. The plurality of property maps/property data sources may for example characterise different object portions (e.g. one property map may detail the properties of a polygon, or a set of polygons, while another property map may detail the properties of a different polygon, or a different set of polygons).

In some examples, there may be a plurality of property maps/property data sources relating to different properties or combinations of properties (for example, surface decoration may be held in a texture map and strength specifications may be stored in a separate data file).

In another example, alternative property maps/property data sources may be provided (or there may be an alternative set of mappings to a property map) for a given property. For example, a high chroma color property map may be supplied along with an alternative lower chroma color property map for cases when using the high chroma property map is determined to be unsuitable given a particular state of system parameters. Alternatively, the high chroma and the low chroma color property data may be included in a single property map (which, as noted above, may map to all or just part of the object), and two sets of mappings may be specified: high chroma mappings and low chroma mappings.

In some examples, such alternatives may be selected based on some parameter value. This can, for example, allow operators to specify preferred fall back options in cases where system parameters mean that a particular specification is not actualisable. High and low chroma are used here simply by way of example of alternatives for a property, and any property may be specified with alternative data sources/mappings.

Block 104 comprises determining (or identifying) a property affecting object generation parameter for the object, for example from the object model. As noted above, in some examples this may be an orientation of a surface portion, which may be derived from a surface normal orientation vector supplied with the data model. In other examples, it may be determined for example by determining the normal to the face using a dot product or the like. Determining the normal to the face may for example be based on a convention. For example, a triangle face normal (for triangle ABC, in that order) may be defined as a unit vector in the direction of the vector cross product (B−A)×(C−A), so as to provide a consistent definition of an outwards facing normal for a face. This may be used to establish a conventional “handedness”. However, alternative conventions may be established and/or utilised to determine the orientation of the face of a surface.

In some examples, the property affecting object generation parameter may comprise an intended object portion position within a build volume of the system, or may comprise an operating temperature of the object generation apparatus, or the like.

Multiple property affecting object generation parameters may be determined for different object portions and/or in relation to different properties.

Block 106 comprises deriving a modified data model of the object by applying a transformation to the property data, wherein the transformation is to (at least partially) compensate for a property value shift associated the color affecting object generation parameter. In some examples, the compensation may be a partial compensation (i.e. the shift may be partially, rather than exactly or completely, compensated for).

In some examples, a data model may be processed in preparation for object generation. For example, an object model may be ‘voxelized’ such that property data is associated with discrete volumes, or voxels, of the object model (as is described in greater detail below). In some examples, the transformation of the property data may be applied after such modification (for example, after ‘voxelization’), while in other examples, the property data may be modified prior to such processing (e.g. a property map or other data file storing property data may be modified directly, or specified mappings to property values may be modified). For example, as outlined above, the property map may be mapped to locations within the object, and it may be the case that the locations may have a different associated parameter value. In such cases, the property map may first be mapped to a voxel model (or some other model of the object), and then the property values of the individual voxels may be transformed using the transformation. In other examples, the mapping may be carried out after the transformation is applied.

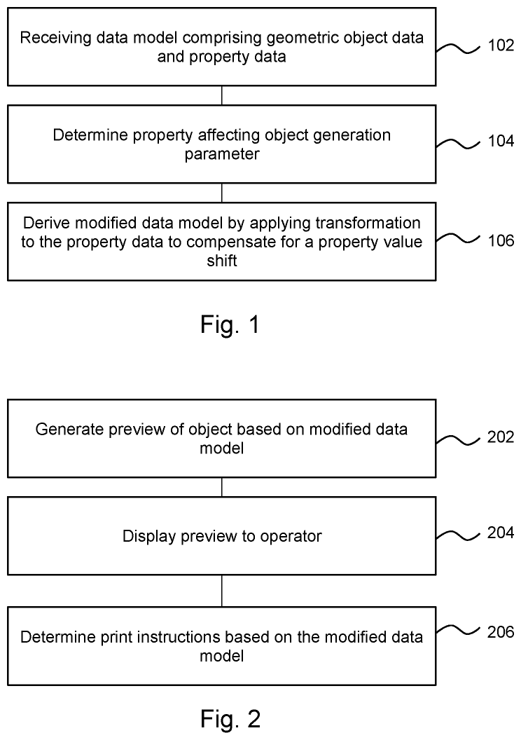

Once such processing and modification has been applied, there may be a further step of generating print instructions, for example as described in relation to FIG. 2 below.

In examples in which the property affecting object generation parameter comprises determining an orientation of a surface portion, deriving the modified data model may comprise applying a transformation to the property data based on the orientation of a surface portion. In examples in which the property affecting object generation parameter is an object portion position within a build volume of the system deriving the modified data model, this may comprise applying a transformation to the property data based on the object portion position. In examples in which the property affecting object generation parameter comprises an intended operating temperature of the object generation apparatus, this may comprise applying a transformation to the property data based on an intended operating temperature. In examples in which the property affecting object generation parameter comprises the type of object generation apparatus, this may comprise applying a transformation to the property data based on the type of object generation apparatus.

As has been noted above, in some examples, two properties may have an interdependence and/or the effect of a particular property affecting object generation parameter on the properties may differ. In such examples two or more shifted property values may be considered, and/or a transformation to the property data may be based jointly on such determined property values. For example, there may be a compromise between compensating for one property value shift and another property value shift. In some examples, there may be a property priority order and compensating for a particular property value shift may take precedence over another. In some examples, this compromise may be made by determining a weighted combination for the transformation applied and/or by compensating for a property shift of a property which is higher in the priority order and not for a property shift of a property which is lower in the priority order.

In some examples, an affected property may be color and the transformation may comprise applying a color shift. For example, it may be the case that an object has first and second faces with a first and a second orientation, and the color data associated with each of these faces in the initial data model may be the same, i.e. it is intended that both faces appear to be the same color in the generated object. In general, it may be the case that a print instruction specifying a particular combination of print agents is selected based on the color data, for example using a mapping or the like. However, as noted above, colors may have an angular dependency: in other words, a print instruction specifying a particular combination of print agents produces a first colorimetry when applied to a face having a first orientation and a second colorimetry when applied to a face having a second orientation.

In such an example, a color shift may be applied to the color data associated with the first and/or second face such that the color specified in the modified data model is different for the first and second faces. However, in practice, this may map to a combination of print agents which, although different for each face, will produce substantially the same colorimetry in both faces when the object is generated: i.e. a color shift associated with the angular dependency of the color has been at least partially compensated for.

In some examples, the transformation may comprise modifying a property map. In other words, the mapping between object data and property data may remain unchanged, but the underlying property data may be color shifted.

By generating a modified data model, subsequent processing may be carried out in a naive manner, without consideration of the orientation angle (or any other color affecting object generation parameter).

The dependency of a property on a parameter may be predetermined. For example, to characterise the angular dependency of color, objects having differently orientated faces may be printed using a consistent print instruction and the colorimetry of the faces measured. In other examples, the same print instruction may be used to generate objects at different temperatures, and/or at different positions within a build volume, and/or using different print apparatus and the colorimetry of the objects measured. In other examples, other properties may be measured instead of or in addition to color, such as strength, density, resilience and the like.

This allows a parameter specific transform to be developed. For example, a mapping to a print instruction may be determined based on a particular parameter (the first parameter value). For example, this may be any (arbitrary) face orientation, temperature, position and/or object generation apparatus, and this may be the basis for a mapping resource to generate print instructions.

The transform may be modelled to determine which print instruction produces an intended property (in this example, color) given a second color affecting parameter value: this in turn may be used to determine a mapping between a color in ‘reference’ frame and a ‘parameter dependent frame’.

For example, it may be determined that a first color is produced by print instruction 1 when the parameter has the first value (e.g. a face has a first orientation) and by print instruction 2 when the parameter has the second value (e.g. an object face has a second orientation). When print instruction 2 is used when the parameter has the first value, a second color may result. Print instructions 1 and 2 may specify different combinations of print agents, for example different proportions of colorants.

In such an example, where the first color is specified in an original object model, and at least a portion of the object will, during object generation, be subjected to the second parameter value, the first color may be transformed to the second color in the modified data model. When print instructions are determined prior to generating the object, this will result in print instruction 2 being selected for this region and the first color actually being produced. In practice, it may not be the case that exactly the same color can be produced for all orientations, and in such an example, the closest available color may be utilised. In other examples, the color data for both parameter values may be transformed, for example so as to result in a color which is intermediate to the first and second color, or some other color which may be attainable for both parameter values.

In general, a transform from a property specification in the data model to a parameter dependent property space may be derived, wherein the property specification in the parameter dependent property space is dependent on the parameter value.

The effects of a parametric dependency on a property may be characterized (for example by printing a set of test objects which is designed to characterise a dependency of the property on a parameter) and this characterization may then be used to generate a modified data model by adjusting the property information of the original data model to compensate for the parameter dependence of the property.

Subsequently, in some examples, when a 3D object is printed, a property of the generated object may be realized in a way that is more consistent and uniform across a range of parameter values (for example, surfaces of different orientation, or locations within the printing volume of the system, or different operating temperatures, or variations in another parametric dependency characteristic). This may be achieved without any direct control of the printing device or any modification of the print agents printed to any particular layer of build material after the determination of print instructions.

As briefly mentioned above, in some examples of additive manufacturing, three-dimensional space may be characterised in terms of voxels, i.e. three-dimensional pixels, wherein each voxel occupies or represents a discrete volume. In some examples, the voxels are determined bearing in mind the print resolution of a print apparatus, such that each voxel represents a volume which may be uniquely addressed when applying print agents, and therefore the properties of one voxel may vary from those of neighbouring voxels. In other words, a voxel may correspond to a volume which can be individually addressed by a print apparatus (which may be a particular print apparatus, or a class of print apparatus, or the like) such that the properties thereof can be determined at least substantially independently of the properties of other voxels. For example, the ‘height’ of a voxel may correspond to the height of a layer of build material. In some examples, the resolution of a print apparatus may exceed the resolution of a voxel, i.e. a voxel may comprise more than one print apparatus addressable location. In general, the voxels of an object model may each have the same shape (for example, cuboid or tetrahedral), but they may in principle differ in shape and/or size. In some examples, voxels are cuboids based on the height of a layer of build material (which may for example be around 80 μm in some examples). For example, the surface area in an xy plane may be around 42 μm by 42 μm (with voxel height being specified in the z axis). In some examples, in processing data representing an object, each voxel may be associated with properties, and/or with print instructions, which apply to the voxel as a whole. In some examples, the modified data model may be represented as a voxel model of the object.

FIG. 2 is an example of a method of determining print instructions for generating an object using additive manufacturing, which may follow the method of FIG. 1. Block 202 comprises generating a preview of an object to be generated. Such an object preview may be generated by modelling the object, for example predicting a color or appearance of an object. The model used to generate the preview may incorporate an anticipated property value shift associated with the property affecting object generation parameter. Block 204 comprises displaying the preview of the object to an operator, for example using a display screen or the like. Although the property data may have been transformed in order to compensate for the shift in the parameter, this compensation may not be perfect; for example, the intended color may not be accessible for a given print apparatus having a particular set of colorants, which can be applied within a particular set of limits. Thus, while the method of FIG. 1 may at least partially compensate for the effect of the property affecting object generation parameter, this may not be entirely successful. By generating a preview, an operator may inspect (and in some examples, adjust) the expected color rendering prior to printing. In some cases, this may alert the operator in cases where achieving an acceptable color uniformity may not be possible due to system parameters. In other examples, the operator may select a different transformation to apply (for example by specifying a different face orientation as a reference orientation).

Block 206 comprises determining print instructions based on the modified data model. In some examples, block 206 is conditional on an operator approving a preview, and/or a modified preview. This may comprise using a mapping resource such as a look-up table on conversion algorithm to identify the coverage of one or more print agents to be applied a region of build material. The placement of the print agents on the build material may be determined using halftoning techniques or the like.

It may be noted that, as property value shift(s) which are predicted to occur in object generation, has or have been at least partially compensated for by the transformation, this determination of print instructions may be carried out in a naive manner, without consideration of a property affecting object generation parameter. Therefore, downstream processing of the data model is simplified. Determining the print instructions may for example comprise use of a look-up table or the like, and the same look up table may be used for a variety of data models, which may model objects having different property affecting object generation parameters, without alteration.

A determined print instruction may for example specify a coverage of one or more print agents (e.g. a fusing agent, colorant or the like) to be applied to a particular region of a layer of build material. In some example, the placement of print agent drops within the region may be determined through use of a halftoning operation.

The method may further comprise generating an object using additive manufacturing based on the print instructions. For example, this may comprise forming successive layers of build material on a print bed and applying print agents according to the control instructions for that layer and exposing the layer to radiation, resulting in heating and fusion of the build material.

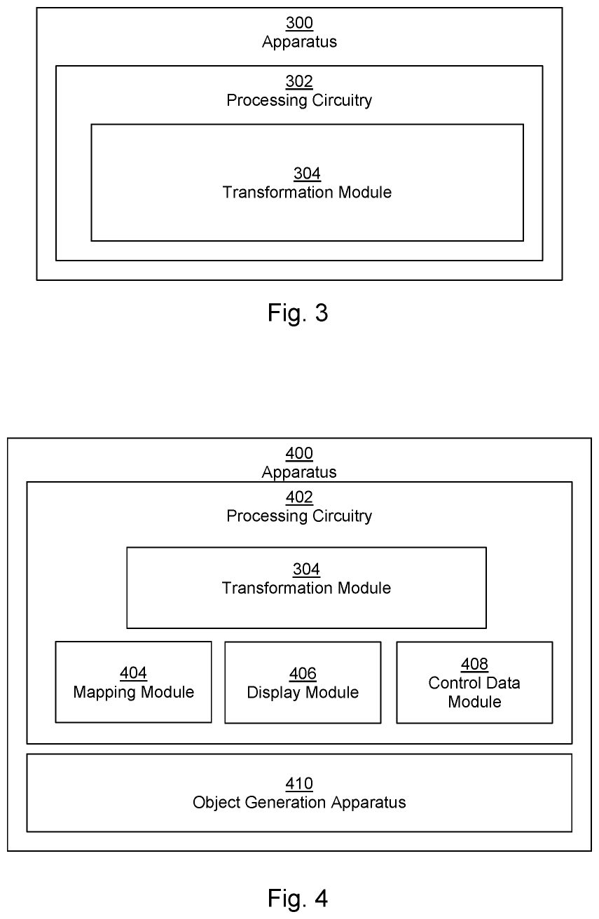

FIG. 3 is an example of an apparatus 300 comprising processing circuitry 302. In this example the processing circuitry 302 comprises a transformation module 304. In use of the apparatus 300, the transformation module 304 receives data representing a three-dimensional object, the data comprising a property data associated with an object, and transforms the property data using at least one transformation to compensate for a property value shift associated with a property affecting object generation parameter in additive manufacturing.

The property data may for example comprise at least one ‘unwrap’ model of the object (e.g. a texture map), or may be defined in some other way (for example, properties may be defined for object vertices, and property data for intermediate locations may be interpolated), or else, property data may be defined in a property map in relation to the faces of a polygon mesh defining the object, or in relation to polytope volumes in a 3D mesh, or in some other way. A property ‘map’ may be any property description which is related to the object geometry by means of a mapping. In other examples, the properties may be defined in some other way, for example being associated with ‘voxels’, or discrete volumes, of the object model.

In some examples, the transformation module 304 transforms the property data using at least one of an orientation specific transformation, a print apparatus specific transformation (e.g. an object generation temperature, a print apparatus type or class), or an object generation position parameter (e.g. an intended position within a build volume).

The processing circuitry 302 may for example carry out the method of FIG. 1.

FIG. 4 shows an example of an apparatus 400 comprising processing circuitry 402 which comprises the transformation module 304 as well as a mapping module 404, a display module 406, and a control data module 408. The apparatus 400 further comprises an object generation apparatus 410.

In use of the apparatus 400, the mapping module 404 maps the transformed property data to object generation instructions for generation of the object. To that end, the mapping module 404 may comprise a mapping resource associating a predetermined set of properties with print instructions for printing print agents in object generation.

The display module 406 is configured to display a representation of the object based on the transformed property data (for example, a transformed property map, or an object model comprising the transformed property data), and may comprise a screen or the like. The display module 406 applies a transformation to model the property shift associated with a property affecting object generation parameter in additive manufacturing before displaying the representation of the object. As noted above, this may function as a ‘preview’ and may allow a user to assess if the compensation for the anticipated property shift (which may in this context be an appearance property such as color) has been carried out in a satisfactory manner.

The control data module 408 generates control data to cause an object generation apparatus to generate an object based on the transformed property data. For example, this may be based on object generation instructions.

The object generation apparatus 410 generates an object according to the control data and may to that end comprise additional components such as a print bed, build material applicator(s), print agent applicator(s), heat sources and the like, not described in detail herein.

The apparatus 400 may carry out the method of FIG. 1 and/or FIG. 2.

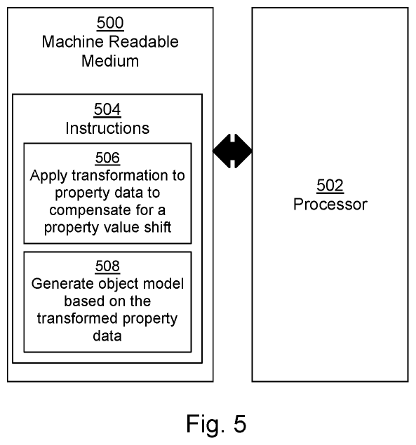

FIG. 5 is an example of a tangible, non-transitory, machine readable medium 500 in association with a processor 502. The machine readable medium 500 stores instructions 504 which, when executed by the processor 502, cause the processor 502 to carry out processes. The instructions 504 comprise instructions 506 to apply a transformation to property data associated with an object to be generated in additive manufacturing to compensate for a property value shift associated with a property affecting object generation parameter (e.g. associated with a surface orientation of a surface of an object to be generated in additive manufacturing) in additive manufacturing and instructions 508 to generate an object model based on the transformed property data.

In some examples, the instructions 504 may comprise instructions to cause the processor 502 generate a voxelized object model comprising the transformed property data. In some examples, the instructions may comprise instructions to cause the processor 502 to generate a voxelized object model based on the original property data, and to transform the property data of the voxelized object model, whereas in other examples, the property data may be transformed and a voxelized object model may be generated based on the transformed property data.

In some examples, the instructions 504 may comprise instructions to cause the processor 502 to determine control instructions for generating an object.

In some examples, the instructions 504 may comprise instructions to cause the processor 502 to apply a plurality of different transformations to portions of property data associated with different object surface portions, the different object surface portions having different orientations.

In some examples, the instructions 504 may comprise instructions to cause the processor 502 to apply an object generation-specific transformation to the property data.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that various blocks in the flow charts and block diagrams, as well as combinations thereof, can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (such as the transformation module 304, mapping module 404, display module 406 and the control data module 408) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claim(s).

1. A method comprising:
receiving a data model of an object to be generated in additive manufacturing, the data model comprising geometric object data describing the object and property data;
determining, by a processor, a property affecting object generation parameter for the object; and
deriving, by a processor, a modified data model of the object by applying a transformation to the property data associated with the property affecting object generation parameter, wherein the transformation is to compensate for a property value shift associated with the property affecting object generation parameter.

2. A method according to claim 1 in which determining the property affecting object generation parameter comprises determining an orientation of an object surface portion and wherein deriving the modified data model comprises applying a transformation to the property data associated with the surface portion.

3. A method according to claim 1 further comprising determining print instructions based on the modified data model.

4. A method according to claim 1 in which determining the property affecting object generation parameter comprises at least one of:
determining an intended object portion position within a build volume of an object generation apparatus; and
determining an operating temperature of the object generation apparatus.

5. A method according to claim 1 in which the method further comprises generating an object preview based on the modified data model.

6. Apparatus comprising processing circuitry, the processing circuitry comprising:
a transformation module to receive data representing a three-dimensional object, the data comprising property data associated with the three-dimensional object, and to transform the property data using at least one transformation to compensate for a property shift associated with a property affecting object generation parameter in additive manufacturing.

7. Apparatus according to claim 6 in which the transformation module is to transform the property data using at least one of an orientation specific transformation; a print apparatus specific transformation; and an object generation position parameter.

8. Apparatus according to claim 6 further comprising a mapping module to map the transformed property data to object generation instructions.

9. Apparatus according to claim 6 further comprising a display module, wherein the display module is to display a representation of the three-dimensional object based on the transformed property data, and wherein the display module applies a transformation to model the property shift associated with a property affecting object generation parameter in additive manufacturing before displaying the representation of the three-dimensional object.

10. Apparatus according to claim 6 further comprising a control data module, the control data module being to generate control data to cause an object generation apparatus to generate an object based on the transformed property data.

11. An apparatus according to claim 10 further comprising an object generation apparatus to generate an object according to the control data.

12. A non-transitory machine readable medium storing instructions which, when executed by a processor, cause the processor to:
apply a transformation to property data associated with an object to be generated in additive manufacturing to compensate for a property value shift associated with a surface orientation of a surface of an object to be generated in additive manufacturing; and
generate an object model based on the transformed property data.

13. A machine readable medium according to claim 12 storing further instructions which, when executed by a processor, cause the processor to:
generate a voxelized object model comprising the transformed property data.

14. A machine readable medium according to claim 12 storing further instructions which, when executed by a processor, cause the processor to:
apply a plurality of different transformations to portions of the property data associated with different object surface portions, the different object surface portions having different orientations.

15. A machine readable medium according to claim 12 storing further instructions which, when executed by a processor, cause the processor to:
apply an object generation-specific transformation to the property data.
